(19) United States
(12) Patent Application Publication
(10) Pub. No.: US 2020/0276622 A1
(43) Pub. Date: Sep. 3, 2020

(54) POWDER REMOVING APPARATUS AND POWDER REMOVING SYSTEM

(71) Applicant: TOSHIBA MEMORY CORPORATION, Minato-ku (JP)

(72) Inventor: Kazunori YOSHIKAWA, Kuwana (JP)

(73) Assignee: TOSHIBA MEMORY CORPORATION, Minato-ku (JP)

(21) Appl. No.: 16/569,346

(22) Filed: Sep. 12, 2019

(30) Foreign Application Priority Data
Mar. 1, 2019 (JP) 2019-037643

(51) Int. Cl. B08B 9/032; F23G 7/06

(52) U.S. Cl. CPC B08B 9/0321; F23G 7/06

(57) ABSTRACT

A powder removing apparatus according to an embodiment includes a first tank in which a powder produced by burning a process gas is collected; a duct with a hollow to which the powder is carried and to which a flow of a liquid is supplied, the duct that is connected to the first tank and that allows the powder to flow from the hollow into the first tank by the flow of the liquid; and a pump that supplies the liquid to the hollow.

### CROSS-REFERENCE TO RELATED APPLICATIONS

This application is based upon and claims the benefit of priority from Japanese Patent Application No. 2019-037643, filed on Mar. 1, 2019; the entire contents of which are incorporated herein by reference.

### FIELD

Embodiments described herein relate generally to a powder removing apparatus and a powder removing system.

### BACKGROUND

Deposition apparatuses may use gas containing a poisonous component in a deposition process on substrates. In such a case, an exhaust gas from the deposition apparatus is decomposed (and removed) by a abatement system.

Such a abatement system produces, for example, silicon dioxide powder through decomposition of a gas. The powder may deposit in a duct, located subsequent to the abatement system, through which a decomposed gas is exhausted to outside. Hence, the abatement system includes a scrubber that captures the powder with water, for example, and prevents the powder from depositing in the duct.

However, the abatement system may produce a large amount of powder, and the scrubber may not be able to capture all of the powder. The powder may then flow into the duct and deposit therein, causing blockage of the duct.

### BRIEF DESCRIPTION OF THE DRAWINGS

FIG. 1 is a diagram schematically illustrating an example of a configuration of a system including a powder removing system and a powder removing apparatus according to an embodiment;

FIG. 2 is a schematic diagram illustrating an example of a abatement system according to the embodiment;

FIG. 3 is a schematic diagram illustrating another example of the abatement system according to the embodiment;

FIG. 4 is a diagram schematically illustrating a modification of the system illustrated in FIG. 1; and

FIG. 5 is a diagram schematically illustrating a modification of the system illustrated in FIG. 1.

### DETAILED DESCRIPTION

According to an embodiment, in general, a powder removing apparatus includes a first tank in which a powder produced by burning a process gas is collected; a duct with a hollow to which the powder is carried and to which a flow of a liquid is supplied, the duct being connected to the first tank and allowing the powder to flow from the hollow into the first tank by the flow of the liquid; and a pump that supplies the liquid to the hollow.

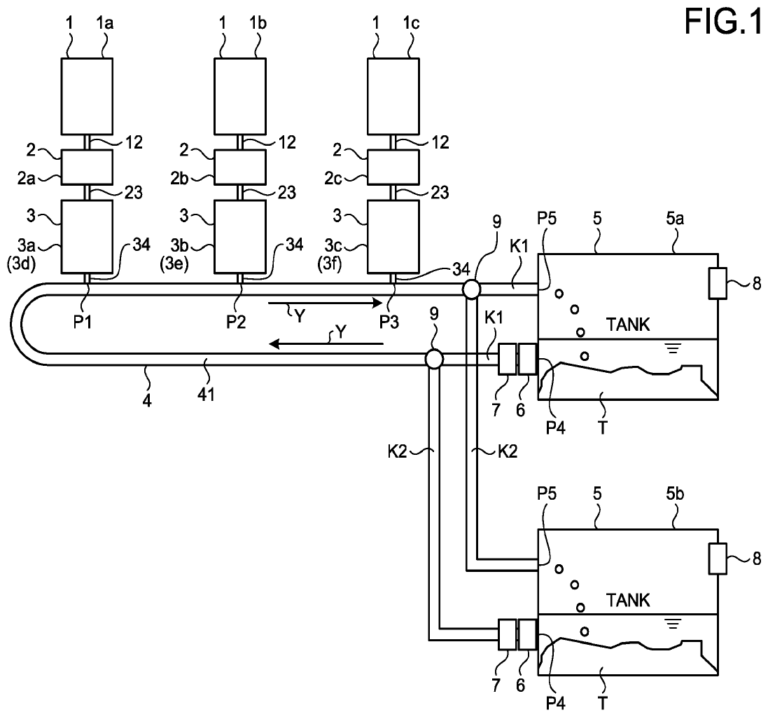

Hereinafter, a powder removing apparatus and a powder removing system according to the embodiment will be described in detail with reference to the accompanying drawings. In the embodiment, the powder removing apparatus includes a duct 4, a tank 5, and a pump 7 as illustrated in FIG. 1, and a powder removing system includes a abatement system 3 in addition to the powder removing apparatus, by way of example. The embodiment is merely exemplary and not intended to limit the scope of the present invention.

FIG. 1 is a diagram schematically illustrating an example of a configuration of a system including the powder removing system and the powder removing apparatus according to the present embodiment. As illustrated in FIG. 1, the system includes a deposition apparatus 1, a vacuum pump 2 (pump), a abatement system 3 (unit), the duct 4, and the tank 5 (first tank).

The deposition apparatus 1 forms a thin film on a substrate. In the deposition apparatus 1, the chamber is placed in a certain vacuum state to allow a gas to flow in the chamber for a deposition process. A gas (process gas) used in a deposition process contains one or more poisonous components such as monosilane (SiH₄), titanium chloride (TiCl₄), and tungsten fluoride (WF₆). Different kinds of gas are used depending on thin films to form. In the embodiment, as one example, the deposition apparatus includes three deposition apparatuses 1a, 1b, and 1c. The deposition apparatus 1a employs monosilane as a deposition gas. The deposition apparatus 1b employs titanium chloride as a deposition gas. The deposition apparatus 1c employs tungsten fluoride as a deposition gas. Hereinafter, the deposition apparatus 1a, the deposition apparatus 1b, and the deposition apparatus 1c will be generically referred to as the deposition apparatus 1.

The vacuum pump 2 is located subsequent to the deposition apparatus 1. The vacuum pump 2 is connected to the deposition apparatus 1 via a pipe 12. The vacuum pump 2 applies a negative pressure to the chamber of the deposition apparatus 1 to exhaust a gas from the chamber. In the embodiment, as one example, the vacuum pump 2 includes a vacuum pump 2a, a vacuum pump 2b, and a vacuum pump 2c. The vacuum pump 2a is connected to the deposition apparatus 1a. The vacuum pump 2b is connected to the deposition apparatus 1b. The vacuum pump 2c is connected to the deposition apparatus 1c. The vacuum pump 2a, the vacuum pump 2b, and the vacuum pump 2c will hereinafter be generically referred to as the vacuum pump 2.

The abatement system 3 is located subsequent to the vacuum pump 2. The abatement system 3 is connected to the vacuum pump 2 via a pipe 23. The abatement system 3 decomposes the gas used in forming a thin film on the substrate by the deposition apparatus 1. The abatement system 3 decomposes an exhaust gas from the deposition apparatus 1 through the vacuum pump 2. The abatement system 3 decomposes the exhaust gas from the deposition apparatus 1a by, for example, burning.

The abatement system 3 produces a product from burning a gas. For example, silicon dioxide (SiO₂) is produced from burning monosilane. Titanium oxide (TiO₂) is produced from burning titanium chloride. Tungsten oxide (WO₃) is produced from burning tungsten fluoride. Such products in the embodiment are in the form of powder T. Hereinafter, exemplary products produced by the abatement system 3 as silicon dioxide, titanium oxide, and tungsten oxide will be generically referred to as powder T.

In the embodiment, as one example, the abatement system 3 includes three abatement systems 3a, 3b, and 3c. The abatement systems 3a is connected to the vacuum pump 2a. That is, the abatement systems 3a is connected to the deposition apparatus 1a via the vacuum pump 2a. The abatement system 3b is connected to the vacuum pump 2b. That is, the abatement system 3b is connected to the deposition apparatus 1b via the vacuum pump 2b. The abatement system 3c is connected to the vacuum pump 2c. That is, the abatement system 3c is connected to the deposition apparatus 1c via the vacuum pump 2c. Additionally, in a modification as will be later described with reference to FIG. 3, a abatement system 3d is used in place of the abatement system 3a, a abatement system 3e is used in place of the abatement system 3b, and a abatement system 3f is used in place of the abatement system 3c.

The abatement system 3a decomposes monosilane used in the deposition apparatus 1a by burning. The abatement system 3a produces silicon dioxide from burning monosilane. The abatement system 3b decomposes titanium chloride used in the deposition apparatus 1b by burning. The abatement system 3b produces titanium oxide from burning titanium chloride. The abatement system 3c decomposes tungsten fluoride used in the deposition apparatus 1c by burning. The abatement system 3c produces tungsten oxide from burning tungsten fluoride. The abatement system 3a, the abatement system 3b, and the abatement system 3c (the abatement system 3d, the abatement system 3e, and the abatement system 3f) may hereinafter be generically referred to as the abatement system 3.

The duct 4 is connected to the tank 5 and includes a hollow 41. The powder T is carried to the hollow 41 into which flows of water are supplied. The duct 4 works to allow the powder T to flow into the tank 5 by a water flow. More specifically, the duct 4 is a tube with the hollow 41 being a space penetrating inside the duct 4. The duct 4 and the hollow 41 have a rectangular prism shape, for example. The hollow 41 has a rectangular cross section. The duct 4 is located subsequent to the abatement system 3. The duct 4 includes a connection P1, a connection P2, and a connection P3. At the connection P1, the duct 4 is connected to the abatement system 3a via a pipe 34. At the connection P2, the duct 4 is connected to the abatement system 3b via the pipe 34. At the connection P3, the duct 4 is connected to the abatement system 3c via the pipe 34. The duct 4 includes a first end P4 and a second end P5.

In the tank 5 (first tank), the powder T, produced by burning the gas used in a deposition on the substrate, is collected. More specifically, the tank 5 has a rectangular parallelepiped shape with a cavity, for example. The tank 5 stores water as an exemplary liquid. The tank 5 accommodates and collects the deposited powder T inside.

A bottom part of the tank 5 is connected to the first end P4 of the duct. The top part of the tank 5 is connected to the second end P5 of the duct. Water stored in the tank 5 is supplied from the first end P4 to the duct 4, flows in the hollow 41 of the duct 4, and is drained or discharged to the tank 5 from the second end P5. The tank 5 is provided with a fan 8 at the top part. The fan 8 emits the decomposed gas, exhausted to the tank 5 from the duct 4, to the outside.

The powder removing apparatus includes a filter 6 that removes the floating powder T from the water, near the first end P4 of the duct 4. The powder removing apparatus also includes a pump 7 near the first end P4 of the duct 4 and subsequent to the filter 6. The pump 7 serves to supply the water to the hollow 41. More specifically, the pump 7 supplies water from the tank 5 to the hollow 41 of the duct 4 through the first end P4, and the filter 6 removes the floating powder T from the water at the same time. That is, the water is supplied from the first end P4 of the tank 5, circulates through the duct 4 in a direction indicated by an arrow Y, is drained from the second end P5, and returns to the tank 5. An amount of water to flow in the hollow 41 of the duct 4 is equal to an amount occupying a lower half of the hollow 41, for example.

The powder T produced by the abatement system 3 is carried through the pipe 34 to the hollow 41 of the duct 4 from the connection P1, the connection P2, or the connection P3. The powder T is then carried toward the tank 5 by the flow of water in the hollow 41. Then, along with the water drainage to the tank 5 through the second end P5, the carried powder T flows into the tank 5. That is, the duct 4 allows the powder T to flow into the tank 5. The powder T then settles and is collected in the water at the bottom of the tank 5.

Also, the gas decomposed by the abatement system 3 flows into the duct 4 from the connection P1, the connection P2, or the connection P3. The decomposed gas is exhausted to the tank 5 through the hollow 41. The exhaust gas is emitted to the outside by the fan 8.

Silicon dioxide, as the powder T produced by the abatement system 3a, is carried to the hollow 41 of the duct 4 via the pipe 34 at the connection P1, is carried by water flowing through the hollow 41 into the tank 5. The Silicon dioxide then settles and is collected at the bottom of the tank 5. Titanium oxide, as the powder T produced by the abatement system 3b, is carried to the hollow 41 of the duct 4 via the pipe 34 at the connection P2, and is carried by water flowing through the hollow 41 into the tank 5. The Titanium oxide then settles and is collected at the bottom of the tank 5. Tungsten oxide, as the powder T produced by the abatement system 3c, is carried to the hollow 41 of the duct 4 via the pipe 34 at the connection P3, and is carried by water flowing through the hollow 41 into the tank 5. The tungsten oxide then settles and is collected at the bottom of the tank 5.

As described above, the powder T is removed from the hollow 41 of the duct 4 by the flow of water, so that the duct 4 is prevented from being blocked by the powder T. To prevent the blockage of the hollow 41, it is possible to dry the powder T carried to the hollow 41 by heating and blow the dried powder T toward the tank 5, for example. However, the powder T carried to the hollow 41 may be sprayed with misty water droplets by a later-described water scrubber 35 and contain a large amount of water. Drying such powder T requires great energy. In contrast, according to the embodiment, the flow of water sweeps away and removes the powder T from the duct 4 into the tank 5, so that the duct 4 can be prevented from being blocked at a lower amount of energy than drying the powder T.

In the meantime, the collected powder T is to be removed from the tank 5 regularly, for example, once a month. In addition, the tank 5 is cleaned up regularly. Hence, the powder removing apparatus preferably includes a plurality of tanks 5.

In the embodiment, the powder removing apparatus includes two tanks 5, i.e., a tank 5a and a tank 5b. The tank 5a and the tank 5b have the same structure. The duct 4 includes a switch 9 in the middle. The switch 9 switches passages of the water containing the powder T in the duct 4 in order to allow the powder T carried to the duct 4 to flow into any of the tanks 5. By switching with the switch 9, the duct 4 is connected to the tank 5a and the tank 5b alternately. Each of the tank 5a and the tank 5b includes the filter 6 and the pump 7.

While the switch 9 switches the passage of the hollow 41 to a passage K1 in the duct 4 to connect the duct 4 to the tank 5a, the pump 7 supplies water from the tank 5a into the duct 4. The duct 4 drains the water from the hollow 41 to the tank 5a, to sweep away the powder T into the tank 5a.

Also, while the switch 9 switches a passage of the hollow 41 to a passage K2 in the duct 4 to connect the duct 4 to the tank 5b, the pump 7 supplies water from the tank 5b to the duct 4. The duct 4 drains the water from the hollow 41 to the tank 5b, to sweep away the powder T into the tank 5b.

According to the embodiment, while the duct 4 is connected to the tank 5a to sweep away and collect the powder T from the duct 4 into the tank 5a, for example, the tank 5b can be cleaned. While the duct 4 is connected to the tank 5b to sweep away and collect the powder T from the duct 4 into the tank 5b, the tank 5a can be cleaned.

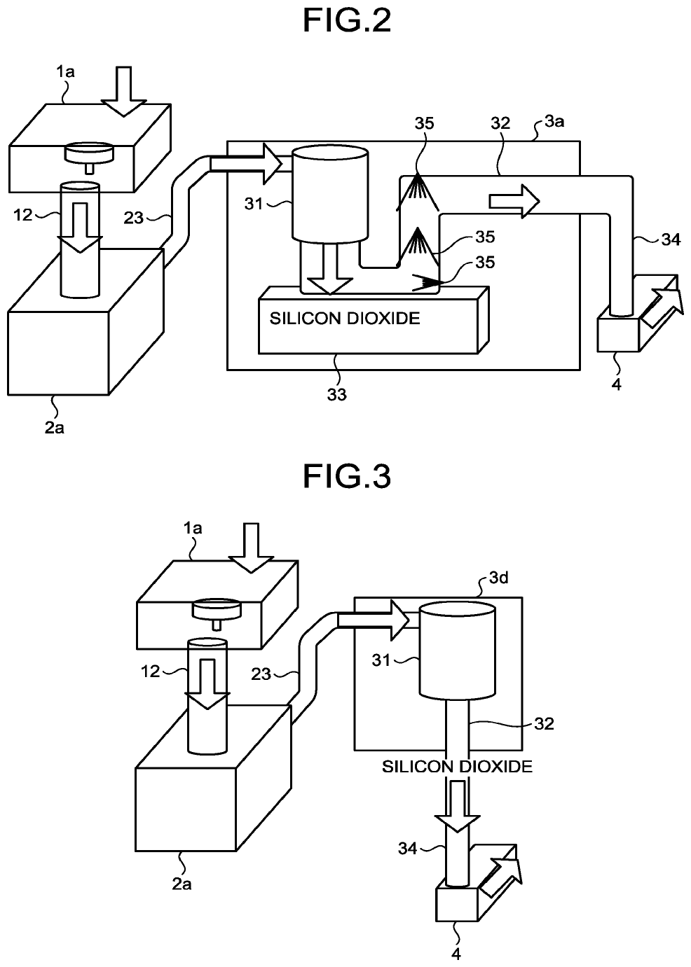

In the following, an exemplary configuration of the abatement system 3 will be described. Herein, the abatement system 3a is described as a representative example. The abatement system 3b and the abatement system 3c have the same structure as the abatement system 3a. FIG. 2 is a schematic diagram illustrating an example of the abatement system 3a according to the embodiment. As illustrated in FIG. 2, the abatement system 3a includes a burner 31, a pipe 32, a tank 33 (a second tank), and the water scrubber 35. The burner 31 works for decomposing monosilane, used by the deposition apparatus 1a and exhausted from the vacuum pump 2, by burning. In the pipe 32, powdery silicon dioxide, produced by the burner 31, floats. The tank 33 serves to capture the silicon dioxide.

The water scrubber 35 sprays water droplets in the form of a shower into the pipe 32. The pipe 32 is provided with a plurality of water scrubbers 35. The water scrubbers 35 each spray misty water droplets in a direction opposite to a flowing direction of floating silicon dioxide, that is, toward an upstream side of the flowing direction in the pipe 32, and captures the floating silicon dioxide in the pipe 32 into the tank 33. In addition, the water scrubbers 35 work to lower the temperature of water vapor or silicon dioxide carried through the pipe 32 by spraying water droplets. The pipe 32 is connected to the pipe 34.

In the example of FIG. 2, the monosilane, used by the deposition apparatus 1a, is exhausted to the abatement system 3a by the vacuum pump 2a. The burner 31 of the abatement system 3a burns the exhausted monosilane. The burner 31 burns the monosilane and produces silicon dioxide. The produced silicon dioxide floats as powder T in the gas. The water droplets sprayed by the water scrubbers 35 capture the floating silicon dioxide in the tank 33 while absorbing moisture. However, part of the silicon dioxide is not captured in the tank 33 but carried to the duct 4 through the pipe 32 and the pipe 34. The silicon dioxide is then carried and swept away from the duct 4 into the tank 5 along with the flow of water in the hollow 41.

In the example in FIG. 2, in order to reduce influences on the surroundings from leakage of the water from the duct 4 to the outside, it is preferable to place the duct 4 in a lower position than the pipe 32, for example, to bury the duct 4 under the floor level. People are likely to stumble upon the duct 4 installed under the floor level.

Next, a modification of the abatement system 3 will be described. FIG. 3 is a schematic diagram illustrating the modification of the abatement system 3 according to the embodiment. The modification in FIG. 3 includes the abatement system 3d in place of the abatement system 3a. As illustrated in FIG. 1, the modification includes the abatement system 3e in place of the abatement system 3b, and the abatement system 3f in place of the abatement system 3c. Herein, the abatement system 3d is described as a representative example. As illustrated in FIG. 3, the abatement system 3d includes the burner 31 and the pipe 32, excluding the tank 33 and the water scrubber 35 of the abatement system 3a. The burner 31 serves to supply oxygen to decompos monosilane by burning. The pipe 32 is connected to the pipe 34. Silicon dioxide, produced by the burner 31, is carried to the duct 4 through the pipe 32 and the pipe 34.

Although not illustrated in FIG. 3, the abatement system 3e does not include the tank 33 and the water scrubber 35 which are included in the abatement system 3b. The abatement system 3f does not include the tank 33 and the water scrubber 35 which are included in the abatement system 3c. The abatement system 3 illustrated in FIG. 3 carries all of the silicon dioxide produced by the burner 31 to the hollow 41 of the duct 4 through the pipe 34.

Such a abatement system 3 illustrated in FIG. 3 is simpler in structure than the abatement system 3 illustrated in FIG. 2, and can be manufactured at a lower cost.

In the example in FIG. 3, the monosilane used by the deposition apparatus 1a is exhausted to the abatement system 3d by the vacuum pump 2a. The burner 31 of the abatement system 3d burns the exhausted monosilane. The burner 31 produces silicon dioxide while burning. The produced silicon dioxide is carried to the duct 4 through the pipe 34. The silicon dioxide is then carried and swept away from the duct 4 into the tank 5 by the water flowing in the hollow 41.

The powder removing apparatuses of the embodiment and the modification includes the tank 5 in which the powder T, produced by burning a gas used in the deposition on a substrate, is collected; the duct 4 that is provided with the hollow 41, is connected to the tank 5, and allows the powder T carried to the hollow 41 to flow into the tank 5 by flows of water supplied to the hollow 41; and the pump 7 that supplies the water to the hollow 41. Hence, the duct 4 is prevented from being blocked by the powder T.

The powder removing systems of the embodiment and the modification include the abatement system 3 that decomposes a gas used in the deposition on a substrate by burning, and produces the powder T along with burning the gas; the tank 5 in which the powder T is collected; the duct 4 that is provided with the hollow 41, is connected to the tank 5, and allows the powder T carried to the hollow 41 to flow into the tank 5 by flows of water supplied to the hollow 41; and the pump 7 that supplies the water to the hollow 41. Thus, the duct 4 is prevented from being blocked by the powder T.

The above embodiment has described the example of using water as a liquid. However, the liquid is not limited to water, and any liquid may be used in addition to water as long as it has a relatively high specific gravity sufficient to sweep away the powder T into the tank 5.

The above embodiment has described the example of using two tanks 5. However, the number of the tanks is not limited thereto. One tank 5 or three or more tanks 5 may be applied.

Further, the above embodiment has described the example of the duct 4 and the hollow 41 both having a rectangular prism shape. However, the shape thereof is not limited to such an example. The duct 4 and the hollow 41 may have a columnar, polygonal prism, or an elliptic columnar shape, for example.

The above embodiment has described the exemplary system including the plurality of deposition apparatuses 1 and the vacuum pump 2 and the abatement system 3 for each of the deposition apparatuses 1. However, the system is not limited to such an example. One vacuum pump 2 and one abatement system 3 may be provided for the deposition apparatuses 1, for example. Alternatively, one abatement system 3 may be provided for the deposition apparatuses 1 and a plurality of vacuum pumps 2. Whether one vacuum pump 2 is provided for each of the deposition apparatuses 1 or for all the deposition apparatuses 1, and whether two or more abatement systems 3 are provided for the deposition apparatuses 1 and two or more vacuum pumps 2 or one abatement system 3 is shared thereby, depend on the amount of a gas used by the deposition apparatus 1, for example.

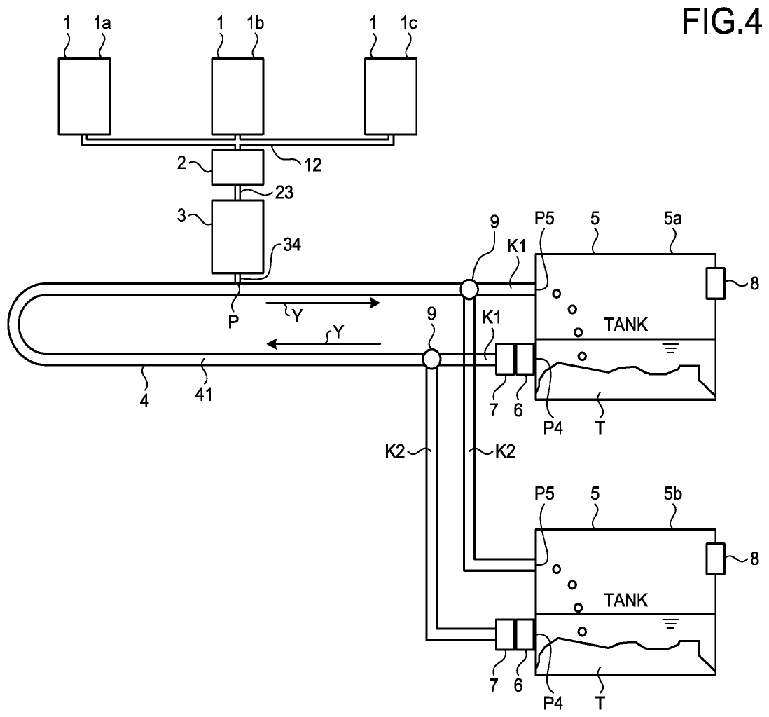

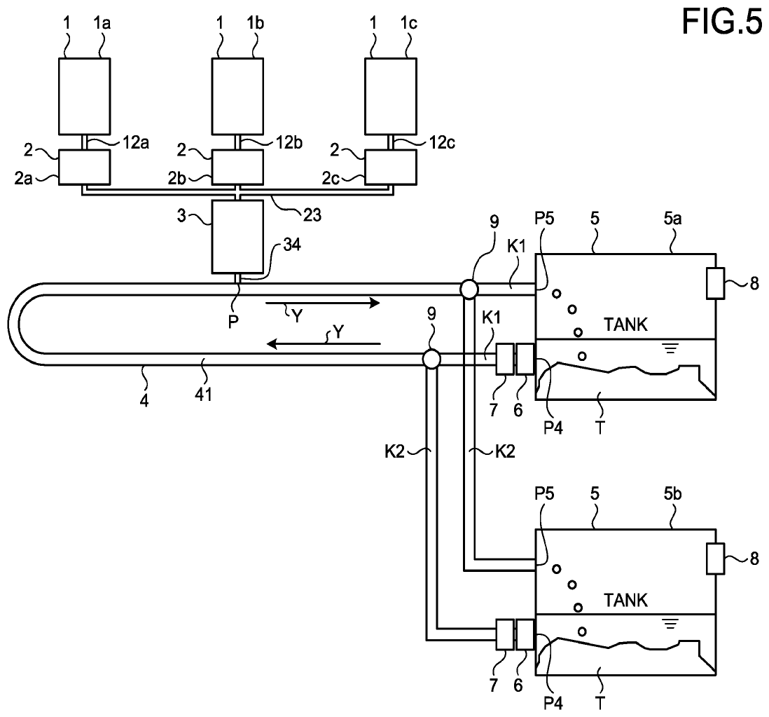

FIGS. 4 and 5 schematically illustrate modifications of the system illustrated in FIG. 1. For example, as illustrated in FIG. 4, the deposition apparatus 1a, the deposition apparatus 1b, and the deposition apparatus 1c are connected to one vacuum pump 2 and one abatement system 3 via the pipe 12. As illustrated in FIG. 5, the deposition apparatus 1a, the deposition apparatus 1b, and the deposition apparatus 1c may be connected to the vacuum pump 2a, the vacuum pump 2b, and the vacuum pump 2c via the pipes 12a, 12b, 12c, respectively. The vacuum pump 2a, the vacuum pump 2b, and the vacuum pump 2c may be connected to one abatement system 3 via the pipe 23. In each of the systems illustrated in FIGS. 4 and 5, the abatement system 3 is connected to the duct 4 via the pipe 34 at a connection P. The abatement system 3 decomposes monosilane used by the deposition apparatus 1a and produces powder, e.g., silicon dioxide. In addition, the abatement system 3 decomposes titanium chloride used by the deposition apparatus 1b and produces powder, e.g., titanium oxide. The abatement system 3 decomposes tungsten fluoride used by the deposition apparatus 1c and produces powder, i.e., tungsten oxide.

The above embodiment has described the powder T as an exemplary product. However, a product is not limited thereto. Any material can be applied as a product in addition to powder as long as it can flow into the tank 5 by a liquid. Examples of the product may include a sand-like substance, such as the one containing particles greater in size than the powder T.

The above embodiment has described the pump 7 configured to supply water from the tank 5 to the duct 4 and circulate the water by way of example. However, the pump 7 is not limited thereto. The pump 7 may be configured to supply the water to the duct 4 from a location other than the tank 5 and drain the water to the tank 5. In other words, the circulation of water described in the embodiment is not essential.

The above embodiment has described the gas used in the deposition process of the system including the deposition apparatus 1 as an exemplary process gas. However, a process gas is not limited thereto. As long as a process gas, which produces the powder T when decomposed by a subsequent abatement system, is supplied, the powder removing apparatus according to the embodiment may be applied to a system including a semiconductor manufacturing apparatus other than a deposition apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A powder removing apparatus comprising:
a first tank in which a powder produced by burning a process gas is collected;
a duct with a hollow to which the powder is carried and to which a flow of a liquid is supplied, the duct being connected to the first tank and allowing the powder to flow from the hollow into the first tank by the flow of the liquid; and
a pump that supplies the liquid to the hollow.

2. The apparatus according to claim 1, wherein
the first tank stores the liquid,
the duct has a first end and a second end both connected to the first tank, and
the pump supplies the liquid from the first tank through the first end of the duct and drains the liquid to the first tank through the second end of the duct, to circulate the liquid in the first tank and the duct and allow the powder to flow into the first tank by the flow of the liquid.

3. The apparatus according to claim 1, wherein
the first tank comprises a plurality of first tanks connected to the duct, the apparatus further comprising
a switch that switches passages of the liquid in the hollow, to allow the powder carried to the hollow to flow into one of the first tanks.

4. The apparatus according to claim 1, wherein
the hollow has a rectangular cross section.

5. The apparatus according to claim 2, further comprising
a filter at the first end of the duct, the filter removing the powder floating in the liquid to be supplied from the first end.

6. A powder removing system comprising:
a unit that decomposes a process gas by burning, and produces powder from burning the process gas;
a first tank in which the powder is collected;
a duct with a hollow to which the powder is carried from the unit and to which a flow of a liquid is supplied, the duct being connected to the unit and the first tank and allowing the powder to flow from the hollow into the first tank by the flow of the liquid; and
a pump that supplies the liquid to the hollow.

7. The system according to claim 6, wherein
the first tank stores the liquid,
the duct has a first end and a second end both connected to the first tank, and
the pump supplies the liquid from the first tank through the first end of the duct and drains the liquid to the first tank through the second end of the duct, to circulate the liquid in the first tank and the duct and allow the powder to flow into the first tank by the flow of the liquid.

8. The system according to claim 6, wherein
the first tank comprises a plurality of first tanks connected to the duct, the system further comprising:
a switch that switches passages of the liquid in the hollow, to allow the powder carried to the hollow to flow into one of the first tanks.

9. The system according to claim 6, wherein
the hollow has a rectangular cross section.

10. The system according to claim 6, wherein
the duct is located below the unit.

11. The system according to claim 10, wherein
the duct is buried in a floor surface.

12. The system according to claim 7, further comprising
a filter at the first end of the duct, the filter removing the powder floating in the liquid to be supplied from the first end.

13. The system according to claim 6, wherein
the unit comprises:
a burner that produces the powder by burning the process gas;
a pipe through which the produced powder and the decomposed process gas are carried to the duct; and
a second tank located in the middle of the pipe in which the produced powder is collected.

14. The system according to claim 13, wherein
the unit further includes a scrubber that sprays water into the pipe to capture the powder into the second tank.

15. The system according to claim 6, wherein
the unit comprises a plurality of units,
the duct is connected to the units,
each of the units is connected to a deposition apparatus that forms a film on a substrate using the process gas, and
the units decompose the process gas used by the deposition apparatus.

16. The system according to claim 6, wherein
the duct is connected to at least one unit,
the at least one unit is connected to a plurality of deposition apparatuses that forms films on substrates using the process gas, and
the at least one unit decomposes the process gas used by each of the deposition apparatuses.

17. A powder removing method by a powder removing apparatus, the apparatus comprising a first tank in which powder produced by burning a process gas is collected; a duct with a hollow, connected to the first tank; and a pump that supplies a liquid to the hollow, the method comprising:
supplying the liquid to the hollow of the duct by the pump; and
causing the powder carried to the hollow to flow into the first tank by flow of the liquid supplied to the hollow.

18. The method according to claim 17, wherein
the duct has a first end and a second end both connected to the first tank in the powder removing apparatus, the method further comprising:
after supplying the liquid from the first tank through the first end of the duct by the pump, draining the liquid to the first tank from the second end of the duct, to circulate the liquid in the first tank and the duct and allow the powder to flow into the first tank by the flow of the liquid.

19. The method according to claim 17, wherein
the first tank comprises a plurality of first tanks connected to the duct in the powder removing apparatus, the method further comprising
switching passages of the liquid in the hollow, to allow the powder carried to the hollow to flow into one of the first tanks.

20. The method according to claim 17, wherein
the process gas includes monosilane, and
the powder includes silicon dioxide produced by burning the monosilane.
